(19) United States
(12) Patent Application Publication
(10) Pub. No.: US 2026/0358674 A1
(43) Pub. Date: Nov. 12, 2026

(54) EVANESCENT FIELD-DRIVEN MICRO OPTICAL WAVEGUIDE ACTUATOR AND METHOD THEREOF

(71) Applicant: ZHEJIANG LAB, Hangzhou (CN)

(72) Inventors: Jianliang XIAO, Hangzhou (CN); Lei ZHANG, Hangzhou (CN); Junhui SHI, Hangzhou (CN); Xiang FU, Hangzhou (CN)

(73) Assignee: ZHEJIANG LAB, Hangzhou (CN)

(21) Appl. No.: 19/719,385

(22) Filed: Jun. 25, 2026

Related U.S. Application Data
(63) Continuation of application No. PCT/CN2025/081232, filed on Mar. 7, 2025.

(30) Foreign Application Priority Data
Jan. 17, 2025 (CN) 202510072652.4

(51) Int. Cl. G02F 1/295

(52) U.S. Cl. CPC G02F 1/295

(57) ABSTRACT

An evanescent field-driven micro optical waveguide actuator and a method thereof are provided. The actuator includes a micro-nano optical fiber, a polymer fiber, and a light source. The polymer fiber is in contact with and connected to one end of the micro-nano optical fiber, and the light source is arranged at the other end of the micro-nano optical fiber. The micro-nano optical fiber is a single-tapered micro-nano optical fiber. The single-tapered micro-nano optical fiber includes a micro-nano optical fiber tapered region located at a middle, a micro-nano optical fiber waist region located at one end, and a micro-nano optical fiber pigtail located at the other end. The polymer fiber is in contact with and connected to an outer surface of the micro-nano optical fiber waist region, and the light source is arranged adjacent to a tail end of the micro-nano optical fiber pigtail.

### CROSS REFERENCE TO THE RELATED APPLICATIONS

This application is a continuation application of International Application No. PCT/CN2025/081232, filed on Mar. 7, 2025, which is based upon and claims priority to Chinese Patent Application No. 202510072652.4, filed on Jan. 17, 2025, the entire contents of which are incorporated herein by reference.

### TECHNICAL FIELD

The present invention relates to the technical field of micro optical waveguide actuation, specifically to an evanescent field-driven micro optical waveguide actuator and a method thereof.

### BACKGROUND

Micro soft actuators that can convert external stimuli into mechanical motion have great application potential in deep-sea exploration, small-scale biological sampling, biomedicine and other fields. Various soft actuators driven by different stimuli, such as magnetic fields, electric fields, temperature, and humidity have been widely reported. Among them, light-driven optical actuators have received particular attention due to their ease of remote control and the adjustability of parameters such as wavelength, intensity, and polarization.

Most traditional optical actuators are triggered by free-space light, which means that there must be a straight optical path between the light source and the actuator. This greatly limits the use of actuators in situations prone to obstruction. Moreover, during long-distance transportation, the intensity of free-space light may decrease significantly, affecting the driving efficiency. For example, in underwater scenarios, especially in deep-water and deep-sea exploration applications, the refraction, scattering, and absorption of water have a significant impact on the intensity and properties of space light, greatly hindering the use and precise control of actuators.

Using optical waveguide to transmit light into actuators is an effective strategy to overcome these limitations, as light can be transmitted over a long distance through optical waveguide, avoiding the influence of the external environment and reducing losses. However, at present, there is a lack of research and development on optical waveguide actuators, and the reported optical waveguide actuators mostly use commercial optical fibers as optical waveguide material, which are large in size (>100 micrometers). This results in large actuator sizes, making miniaturization difficult, and can easily lead to size mismatches with photoresponsive materials, thereby reducing energy utilization rate. Therefore, existing optical waveguide-type actuators currently have small deformation ranges and long response times, making it difficult to meet the needs of practical applications.

### SUMMARY

To address the shortcomings of the prior art, it is desirable to develop a micro optical waveguide actuator with a large deformation capability, which has significant scientific value and application value. Therefore, the present invention provides an evanescent field-driven micro optical waveguide actuator.

The technical solution of the present invention is as follows:

### 1. An Evanescent Field-Driven Micro Optical Waveguide Actuator

The micro optical waveguide actuator includes a micro-nano optical fiber, a polymer fiber, and a light source, where the polymer fiber is in contact with and connected to one end of the micro-nano optical fiber, and the light source is arranged at the other end of the micro-nano optical fiber; and the micro-nano optical fiber has a waist region, and the polymer fiber with a different material property from the micro-nano optical fiber is arranged at the waist region.

The micro-nano optical fiber is mainly a single-tapered micro-nano optical fiber, which is prepared by a thermal stretching method. The single-tapered micro-nano optical fiber includes a micro-nano optical fiber tapered region located at a middle, a micro-nano optical fiber waist region located at one end, and a micro-nano optical fiber pigtail located at the other end. That is, the micro-nano optical fiber tapered region is located between the micro-nano optical fiber waist region and the micro-nano optical fiber pigtail. The micro-nano optical fiber waist region passes through the polymer fiber, and the polymer fiber is in contact with and connected to a surface of the micro-nano optical fiber waist region. The light source is arranged adjacent to a tail end of the micro-nano optical fiber pigtail.

Specifically, the polymer fiber is tightly attached to the surface of the micro-nano optical fiber waist region.

Light is generated and emitted by the light source, and then incident into the single-tapered micro-nano optical fiber, so that an evanescent field is generated around the micro-nano optical fiber waist region. The light is incident into the single-tapered micro-nano optical fiber from the micro-nano optical fiber pigtail and propagates, and passes through the micro-nano optical fiber tapered region to reach the micro-nano optical fiber waist region.

The polymer fiber is doped with a photothermal conversion material.

A refractive index of the polymer fiber is greater than a refractive index of a core of the single-tapered micro-nano optical fiber, and a coefficient of thermal expansion of the polymer fiber is different from a coefficient of thermal expansion of the micro-nano optical fiber waist region.

Preferably, the polymer fiber is typically made of polymethyl methacrylate fiber, thermoplastic polyurethane, liquid crystal elastomer, hydrogel, polyethylene, polystyrene, or the like, and the photothermal conversion material is specifically gold nanoparticles, gold nanorods, graphene, carbon nanotubes, dye, or the like.

More preferably, the polymer fiber is any one of polymer fiber I, polymer fiber II, polymer fiber III, and polymer fiber IV.
1) Polymethyl methacrylate and photothermal dye are added to N,N-dimethylformamide until dissolved, with a mass amount of polymethyl methacrylate being 20-1000 times that of the photothermal dye. Then, using electrospinning and parallel plate electrodes, oriented polymethyl methacrylate fibers are obtained as the polymer fiber I. Subsequently, the polymer fiber I is placed on the micro-nano optical fiber waist region using micromanipulation. Then, the polymer fiber I placed on the micro-nano optical fiber waist region is treated with N,N-Dimethylformamide vapor to obtain a micro-nano optical fiber waist region bonded with the polymer fiber I as the actuator I.
2) Polyethylene glycol-modified gold nanorods are dispersed in N,N-Dimethylformamide, and then dissolved in thermoplastic polyurethane, with a mass amount of the thermoplastic polyurethane being 500-5000 times that of the gold nanorods, to obtain the mixed solution I. Subsequently, the mixed solution I is printed onto the micro-nano optical fiber waist region using microelectronic printing technology to serve as the polymer fiber II. After drying and curing, a micro-nano optical fiber waist region bonded with the polymer fiber II is obtained as the actuator II.
3) N-isopropylacrylamide, acrylic acid, acrylamide benzophenone, and azobisisobutyronitrile (AIBN) are dissolved in 1,4-dioxane, heated for reaction, and dried to obtain Poly(N-isopropylacrylamide) (PNIPAM). Polyethylene glycol-modified gold nanorods are dispersed in propanol, and then the PNIPAM is added until dissolved, with a mass amount of the PNIPAM being 500-5000 times that of the gold nanorods, to obtain the mixed solution II. Subsequently, the mixed solution II is printed onto the micro-nano optical fiber waist region using microelectronic printing technology to serve as the polymer fiber III. After (UV) ultraviolet irradiation, a micro-nano optical fiber waist region bonded with the polymer fiber III is obtained. Then, the micro-nano optical fiber waist region bonded with the polymer fiber III is immersed in a mixed solvent of ethanol and water to serve as the actuator III.
4) Liquid crystal monomers, a chain extender, a free radical inhibitor, a crosslinking agent, a photoinitiator, a catalyst, and photothermal dye are mixed together to obtain the mixed solution III, where a mass ratio of the photothermal dye in the mixed solution III is 0.1%-5%. The mixed solution is heated in the dark to carry out an oligomerization reaction to obtain liquid crystal elastomer ink. Subsequently, the liquid crystal elastomer ink mode is printed onto the micro-nano optical fiber waist region using microelectronic printing technology to serve as the polymer fiber IV. After UV irradiation, a micro-nano optical fiber waist region bonded with the polymer fiber IV is obtained as the actuator IV.

### 2. An Evanescent Field-Driven Micro Optical Waveguide Actuation Method Based on the Micro Optical Waveguide Actuator

The method is as follows:
generating and emitting light by the light source, where the light is then incident into the single-tapered micro-nano optical fiber, and generating an evanescent field around the micro-nano optical fiber waist region of the single-tapered micro-nano optical fiber; where a refractive index of the polymer fiber is greater than a refractive index of the micro-nano optical fiber waist region, so that the light is transmitted into and absorbed by the polymer fiber, and accordingly a temperature of the polymer fiber and a temperature of the micro-nano optical fiber waist region rise, resulting in the difference between the temperature of the polymer fiber and the temperature of the micro-nano optical fiber waist region. Since a coefficient of thermal expansion of the polymer fiber is different from a coefficient of thermal expansion of the micro-nano optical fiber waist region, the micro optical waveguide actuator undergoes bending deformation.

After the polymer fiber absorbs the light, the temperature of the polymer fiber and the temperature of the micro-nano optical fiber waist region rise under action of the photothermal material, so that the polymer fiber and the micro-nano optical fiber waist region bend and deform in a direction of small thermal expansion deformation.

Compared with the prior art, the beneficial effects of the present invention are:
(1) It overcomes the shortcomings of traditional actuators, such as susceptibility to spatial constraints, and difficulty in miniaturization and remote precise control.
(2) It offers strong controllability and fast response speed.
(3) Driven by the evanescent field generated in the micro-nano optical fiber waist region, the driving light can be efficiently introduced into the deformable material, improving energy utilization.

### BRIEF DESCRIPTION OF THE DRAWINGS

FIG. 1 is a schematic diagram of the structure of the micro optical waveguide actuator.

FIG. 2 is a cross-sectional view of the structure in FIG. 1 along A-A.

FIG. 3 is a microscopic image of polymethyl methacrylate-oriented nanofibers collected using parallel plate electrodes.

FIG. 4 is a schematic diagram of deformation of the actuator when the coefficient thermal expansion of the polymer fiber is greater than that of the micro-nano optical fiber waist region.

FIG. 5 is a schematic diagram of deformation of the actuator when the coefficient thermal expansion of the polymer fiber is less than that of the micro-nano optical fiber waist region.

In the figures: 1, micro-nano optical fiber; 101, micro-nano optical fiber waist region. 102, micro-nano optical fiber tapered region; 103, micro-nano optical fiber pigtail; 2, polymer fiber; and 3, light source.

### DETAILED DESCRIPTION OF THE EMBODIMENTS

The present invention will be further described in detail below with reference to the drawings and specific embodiments.

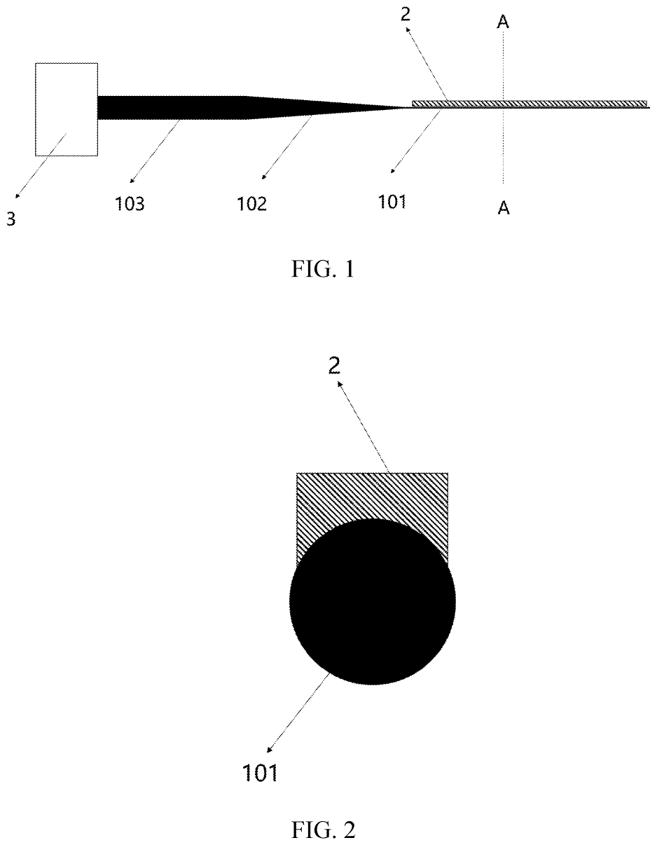

As shown in FIG. 1, a micro optical waveguide actuator includes a micro-nano optical fiber, the polymer fiber 2, and the light source 3. The polymer fiber 2 is in contact with and connected to one end of the micro-nano optical fiber, and the light source 3 is arranged at the other end of the micro-nano optical fiber. The micro-nano optical fiber has a waist region, and the polymer fiber 2 with a different material property from the micro-nano optical fiber is arranged at the waist region.

The micro-nano optical fiber is mainly the single-tapered micro-nano optical fiber which is prepared by a thermal stretching method. The single-tapered micro-nano optical fiber 1 includes the micro-nano optical fiber tapered region 102 located at the middle, the micro-nano optical fiber waist region 101 located at one end, and the micro-nano optical fiber pigtail 103 located at the other end. That is, the micro-nano optical fiber tapered region 102 is located between the micro-nano optical fiber waist region 101 and the micro-nano optical fiber pigtail 103. The micro-nano optical fiber waist region 101 passes through the polymer fiber 2, and the polymer fiber 2 is in contact with and connected to the surface of the micro-nano optical fiber waist region 101. The light source 3 is arranged adjacent to a tail end of the micro-nano optical fiber pigtail 103.

Light is generated and emitted by the light source 3, and then incident into the single-tapered micro-nano optical fiber 1, so that an evanescent field is generated around the micro-nano optical fiber waist region 101. Light is incident into the single-tapered micro-nano optical fiber 1 from the micro-nano optical fiber pigtail 103 and propagates, and passes through the micro-nano optical fiber tapered region 102 to reach the micro-nano optical fiber waist region 101.

In the specific implementation, the polymer fiber 2 is attached to the surface of the micro-nano optical fiber waist region 101. The polymer fiber 2 is doped with a photothermal conversion material. The refractive index of the polymer fiber 2 is greater than the refractive index of the core of the single-tapered micro-nano optical fiber 1, and the coefficient of thermal expansion of the polymer fiber 2 is different from the coefficient of thermal expansion of the micro-nano optical fiber waist region 101.

The working process of the actuator according to the present invention is specifically implemented as follows:

Light is generated and emitted by the light source 3, and then incident into the single-tapered micro-nano optical fiber 1. The evanescent field is generated around the micro-nano optical fiber waist region 101 of the single-tapered micro-nano optical fiber 1. Since the refractive index of the polymer fiber is greater than the refractive index of the micro-nano optical fiber waist region, the light in the evanescent field is transmitted into and absorbed by the polymer fiber 2, and is converted into heat energy under the action of the photothermal conversion material, causing the temperature of the polymer fiber 2 and the temperature of the micro-nano optical fiber waist region 101 to rise. Since the coefficient of thermal expansion of the polymer fiber 2 is different from the coefficient of thermal expansion of the micro-nano optical fiber waist region 101, the difference occurs between the temperature of the polymer fiber 2 and the temperature of the micro-nano optical fiber waist region 101. Since the coefficient of thermal expansion of the polymer fiber 2 is different from the coefficient of thermal expansion of the micro-nano optical fiber waist region 101, the micro optical waveguide actuator undergoes bending deformation.

Specifically, when the coefficient of thermal expansion of the polymer fiber 2 is greater than the coefficient of thermal expansion of the micro-nano optical fiber waist region 101, after the polymer fiber 2 absorbs the light, both the temperature of the polymer fiber 2 and the temperature of the micro-nano optical fiber waist region 101 rise under the action of the photothermal material. The thermal expansion deformation of the polymer fiber 2 is greater than that of the micro-nano optical fiber waist region 101, and the actuator bends and deforms in the direction of small thermal expansion deformation, i.e., towards the side of the micro-nano optical fiber waist region 101.

When the coefficient of thermal expansion of the polymer fiber 2 is less than the coefficient of thermal expansion of the micro-nano optical fiber waist region 101, after the polymer fiber 2 absorbs the light, both the temperature of the polymer fiber 2 and the temperature of the micro-nano optical fiber waist region 101 rise under the action of the photothermal material. The thermal expansion deformation of the polymer fiber 2 is less than that of the micro-nano optical fiber waist region 101, and the actuator bends and deforms in the direction of small thermal expansion deformation, i.e., towards the side of the polymer fiber 2.

The embodiments of the present invention are as follows:

### Example 1

The schematic diagram of the structure of the micro optical waveguide actuator is shown in FIG. 1. In this example, the coefficient of thermal expansion of the polymer fiber 2 is greater than the coefficient of thermal expansion of the micro-nano optical fiber waist region 101.

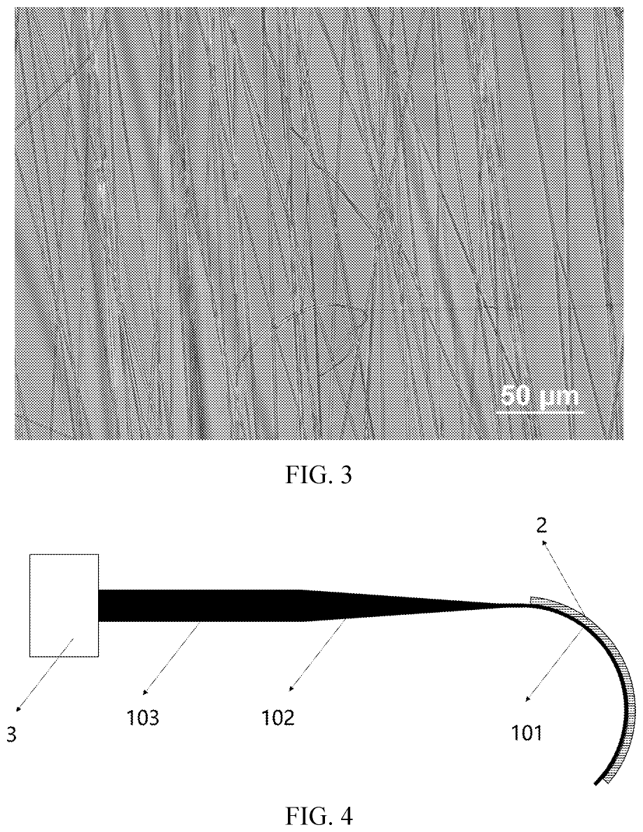

Polymethyl methacrylate (PMMA) and a certain amount of photothermal dye were dissolved in N,N-dimethylformamide. PMMA fibers were then prepared using electrospinning, and the oriented PMMA fibers were collected using parallel plate electrodes. The morphology of the resulting oriented fibers is shown in FIG. 3. The orientation of the fibers facilitates subsequent micromanipulation of the PMMA fibers and reduces the overlap and adhesion between disordered stacked nanofibers.

The micro-nano optical fiber 1 was prepared using the thermal stretching method. Then, the PMMA fiber was placed on the micro-nano optical fiber waist region 101 of the micro-nano optical fiber 1 using micromanipulation to serve as the polymer fiber 2. The polymer fiber 2 and the micro-nano optical fiber 1 were firmly bonded after being treated with N,N-dimethylformamide vapor for 1 min to obtain the micro optical waveguide actuator.

When the actuator operates, the pigtail 103 of the micro-nano optical fiber 1 is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the photothermal dye, causing the temperature to rise. Since the coefficient of thermal expansion of the polymer fiber 2 is higher than the coefficient of thermal expansion of the waist region 101 of the micro-nano optical fiber 1, the optical actuator bends and deforms towards the side of the micro-nano optical fiber 1. The deformation effect is shown in FIG. 4.

### Example 2

In this example, the coefficient of thermal expansion of the polymer fiber 2 is greater than the coefficient of thermal expansion of the micro-nano optical fiber waist region 101.

The micro-nano optical fiber 1 was prepared using the thermal stretching method. Polyethylene glycol-modified gold nanorods (AuNR) were dispersed in N,N-dimethylformamide, and then dissolved in thermoplastic polyurethane (TPU). Subsequently, the TPU/AuNR solution was printed onto the waist region 101 of the micro-nano optical fiber 1 using microelectronic printing technology to serve as the polymer fiber 2. After drying and curing, the micro optical waveguide actuator was obtained.

When the optical actuator operates, the pigtail 103 of the micro-nano optical fiber is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the AuNR, causing the temperature to rise. Since the coefficient of thermal expansion of the polymer fiber 2 is higher than the coefficient of thermal expansion of the waist region 101 of the micro-nano optical fiber 1, the optical actuator bends and deforms towards the side of the micro-nano optical fiber 1. The deformation effect is shown in FIG. 4.

### Example 3

The A-A cross-sectional view of the micro optical waveguide actuator is shown in FIG. 2. In this example, the coefficient of thermal expansion of the polymer fiber is less than the coefficient of thermal expansion of the micro-nano optical fiber waist region.

N-isopropylacrylamide, acrylic acid, acrylamide benzophenone, and AIBN were dissolved in 1,4-dioxane and reacted at 80 °C for 15 h. After drying, PNIPAM was obtained. Polyethylene glycol-modified AuNR was dispersed in propanol, and then dissolved in PNIPAM. The micro-nano optical fiber 1 was prepared using the thermal stretching method. Subsequently, the PNIPAM/AuNR solution was printed onto the waist region 101 of the micro-nano optical fiber 1 using microelectronic printing technology to serve as the polymer fiber 2, and crosslinked by UV irradiation for 60 min. It was then immersed in the water/ethanol mixed solvent to remove unreacted parts, obtaining the micro optical waveguide actuator.

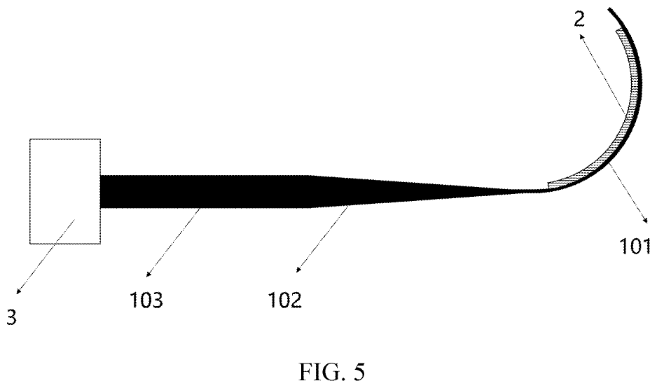

When the optical actuator operates, the pigtail 103 of the micro-nano optical fiber 1 is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the AuNR, causing the temperature to rise. Since PNIPAM has thermal shrinkage, that is, the coefficient of thermal expansion of the polymer fiber 2 is lower than the coefficient of thermal expansion of the waist region 101 of the micro-nano optical fiber 1, the optical actuator bends and deforms to the side of the polymer fiber 2. The deformation effect is shown in FIG. 5.

### Example 4

In this example, the coefficient of thermal expansion of the polymer fiber is less than the coefficient of thermal expansion of the micro-nano optical fiber waist region.

Liquid crystal monomer 1,4-bis-[4-(3-acryloyloxypropyloxy)benzoyloxy]-2-methylbenzene (RM 257), chain extender ethane-1,2-diyl bis(3-mercaptopropionate) (EDDET), free radical inhibitor butylated hydroxytoluene (BHT), crosslinking agent pentaerythritol tetraacrylate (PETA), photoinitiator phenylbis(2,4,6-trimethylbenzoyl)phosphine oxide (PI 819), catalyst triethylamine (TEA), and photothermal dye were mixed together and reacted at 80 °C for 45 min in the dark to carry out the oligomerization reaction, obtaining liquid crystal elastomer (LCE) ink.

The micro-nano optical fiber 1 was prepared using the thermal stretching method. Subsequently, the LCE mode was printed onto the waist region 101 of the micro-nano optical fiber 1 using microelectronic printing technology to serve as the polymer fiber 2, and crosslinked by UV irradiation for 60 min, obtaining the micro optical waveguide actuator.

When the optical actuator operates, the pigtail 103 of the micro-nano optical fiber 1 is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the photothermal dye, causing the temperature to rise. Since LCE has thermal shrinkage, i.e., the coefficient of thermal expansion of the polymer fiber 2 is lower than the coefficient of thermal expansion of the waist region 101 of the micro-nano optical fiber 1, the optical actuator bends and deforms towards the side of the polymer fiber 2. The deformation effect is shown in FIG. 5.

### Example 5

In this example, the coefficient of thermal expansion of the polymer fiber 2 is greater than the coefficient of thermal expansion of the micro-nano optical fiber waist region 101.

The micro-nano optical fiber 1 was prepared using the thermal stretching method. Polyethylene (PE) resin particles and photothermal dye were mixed at a high temperature using a twin-screw extruder, where the mass ratio of the photothermal dye to the PE resin particles is 0.1%-5%. The resulting mixture was cooled, regranulated, and then added to a printer nozzle equipped with a heating function. Subsequently, the PE melt mixed with the photothermal dye was printed onto the waist region 101 of the micro-nano optical fiber 1 using microelectronic printing technology to serve as the polymer fiber 2. After cooling and curing, the micro optical waveguide actuator was obtained.

When the optical actuator operates, the pigtail 103 of the micro-nano optical fiber 1 is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the photothermal dye, causing the temperature to rise. Since the coefficient of thermal expansion of the polymer fiber 2 is higher than the coefficient of thermal expansion of the waist region 101 of the micro-nano optical fiber 1, the optical actuator bends and deforms towards the side of the micro-nano optical fiber 1. The deformation effect is shown in FIG. 4.

### Example 6

The schematic diagram of the structure of the micro optical waveguide actuator is shown in FIG. 1. In this example, the coefficient of thermal expansion of the polymer fiber 2 is greater than the coefficient of thermal expansion of the micro-nano optical fiber waist region 101.

Polyethylene glycol-modified gold nanorods (AuNR) were dispersed in tetrahydrofuran and dissolved in polystyrene (PS) to obtain the AuNR/PS solution. PS fibers were then prepared using electrospinning. The resulting PS fiber mat was cut into small pieces and then immersed in ethanol. The PS fiber mat was then dispersed using a high-speed disperser at 14000 rpm, forming the single PS short fiber dispersion solution in ethanol. This dispersion solution was drop-coated onto a silicon wafer and dried to obtain single PS short fibers. The originally overlapping and adhered nanofibers are dispersed into single short fibers to facilitate subsequent micromanipulation of the PS fibers.

The micro-nano optical fiber 1 was prepared using the thermal stretching method. Subsequently, the PS short fiber was placed on the micro-nano optical fiber waist region 101 of the micro-nano optical fiber 1 using micromanipulation to serve as the polymer fiber 2. The polymer fiber 2 and the micro-nano optical fiber 1 were firmly bonded after being treated with tetrahydrofuran vapor for 1 min to obtain the micro optical waveguide actuator.

When the actuator operates, the pigtail 103 of the micro-nano optical fiber 1 is connected to the light source 3. When light is transmitted to the waist region 101 of the micro-nano optical fiber 1, the evanescent field is generated on the surface of the waist region 101. Since the refractive index of the polymer fiber 2 is greater than the refractive index of the waist region 101 of the micro-nano optical fiber 1, the light in the evanescent field can be absorbed by the polymer fiber 2 and converted into heat energy under the action of the photothermal dye, causing the temperature to rise. Since the coefficient of thermal expansion of the polymer fiber 2 is higher than the coefficient of thermal expansion of the waist region 101 of the micro-nano optical fiber 1, the optical actuator bends and deforms towards the side of the micro-nano optical fiber 1. The deformation effect is shown in FIG. 4.

The above specific embodiments are used to explain and illustrate the present invention, not to limit the present invention. Any modifications and changes made to the present invention within the spirit of the present invention and protection scope of the claims shall fall within the protection scope of the present invention.

The above only describes the preferred embodiment of the present invention. Therefore, all equivalent changes or modifications made to the configurations, features, and principles described in the present invention patent application are included within the scope of the present invention patent application.

What is claimed is:

1. An evanescent field-driven micro optical waveguide actuator,
comprising a micro-nano optical fiber, a polymer fiber, and a light source, wherein the polymer fiber is in contact with and connected to one end of the micro-nano optical fiber, and the light source is arranged at the other end of the micro-nano optical fiber; and the micro-nano optical fiber has a waist region, and the polymer fiber with a different material property from the micro-nano optical fiber is arranged at the waist region; and
light is generated and emitted by the light source, and then incident into a single-tapered micro-nano optical fiber, so that an evanescent field is generated around a micro-nano optical fiber waist region; and the light is incident into the single-tapered micro-nano optical fiber from a micro-nano optical fiber pigtail and propagates, and passes through a micro-nano optical fiber tapered region to reach the micro-nano optical fiber waist region.

2. The evanescent field-driven micro optical waveguide actuator according to claim 1, wherein the micro-nano optical fiber is mainly the single-tapered micro-nano optical fiber, and the single-tapered micro-nano optical fiber comprises the micro-nano optical fiber tapered region located at a middle, the micro-nano optical fiber waist region located at one end, and the micro-nano optical fiber pigtail located at the other end; and the micro-nano optical fiber waist region passes through the polymer fiber, and the polymer fiber is in contact with and connected to a surface of the micro-nano optical fiber waist region; and the light source is arranged adjacent to a tail end of the micro-nano optical fiber pigtail.

3. The evanescent field-driven micro optical waveguide actuator according to claim 1, wherein the polymer fiber is attached to a surface of the micro-nano optical fiber waist region.

4. The evanescent field-driven micro optical waveguide actuator according to claim 1, wherein the polymer fiber is doped with a photothermal conversion material.

5. The evanescent field-driven micro optical waveguide actuator according to claim 4, wherein a refractive index of the polymer fiber is greater than a refractive index of a core of the single-tapered micro-nano optical fiber, and a coefficient of thermal expansion of the polymer fiber is different from a coefficient of thermal expansion of the micro-nano optical fiber waist region.

6. An evanescent field-driven micro optical waveguide actuation method of the micro optical waveguide actuator according to claim 1, comprising:
generating and emitting the light by the light source, wherein the light is then incident into the single-tapered micro-nano optical fiber, and generating the evanescent field around the micro-nano optical fiber waist region of the single-tapered micro-nano optical fiber; wherein a refractive index of the polymer fiber is greater than a refractive index of the micro-nano optical fiber waist region, so that the light is transmitted into and absorbed by the polymer fiber, and accordingly a temperature of the polymer fiber and a temperature of the micro-nano optical fiber waist region rise; and since a coefficient of thermal expansion of the polymer fiber is different from a coefficient of thermal expansion of the micro-nano optical fiber waist region, the micro optical waveguide actuator undergoes bending deformation.

7. The evanescent field-driven micro optical waveguide actuation method according to claim 6, wherein after the polymer fiber absorbs the light, the temperature of the polymer fiber and the temperature of the micro-nano optical fiber waist region rise under an action of a photothermal material, so that the polymer fiber and the micro-nano optical fiber waist region bend and deform in a direction of small thermal expansion deformation.

8. The evanescent field-driven micro optical waveguide actuation method according to claim 6, wherein in the micro optical waveguide actuator, the micro-nano optical fiber is mainly the single-tapered micro-nano optical fiber, and the single-tapered micro-nano optical fiber comprises the micro-nano optical fiber tapered region located at a middle, the micro-nano optical fiber waist region located at one end, and the micro-nano optical fiber pigtail located at the other end; and the micro-nano optical fiber waist region passes through the polymer fiber, and the polymer fiber is in contact with and connected to a surface of the micro-nano optical fiber waist region; and the light source is arranged adjacent to a tail end of the micro-nano optical fiber pigtail.

9. The evanescent field-driven micro optical waveguide actuation method according to claim 6, wherein in the micro optical waveguide actuator, the polymer fiber is attached to a surface of the micro-nano optical fiber waist region.

10. The evanescent field-driven micro optical waveguide actuation method according to claim 6, wherein in the micro optical waveguide actuator, the polymer fiber is doped with a photothermal conversion material.

11. The evanescent field-driven micro optical waveguide actuation method according to claim 10, wherein in the micro optical waveguide actuator, the refractive index of the polymer fiber is greater than a refractive index of a core of the single-tapered micro-nano optical fiber, and the coefficient of thermal expansion of the polymer fiber is different from the coefficient of thermal expansion of the micro-nano optical fiber waist region.
